(19) United States
(12) Patent Application Publication
(10) Pub. No.: US 2022/0397961 A1
(43) Pub. Date: Dec. 15, 2022

(54) CONTROL DEVICE, PROGRAM, AND SYSTEM

(71) Applicant: KABUSHIKI KAISHA TOKAI RIKA DENKI SEISAKUSHO, Aichi (JP)

(72) Inventors: Keiji NOMURA, Aichi (JP); Toshihito TAKAI, Aichi (JP); Ayano ITO, Aichi (JP); Kazuhiro TAKECHI, Aichi (JP)

(73) Assignee: KABUSHIKI KAISHA TOKAI RIKA DENKI SEISAKUSHO, Aichi (JP)

(21) Appl. No.: 17/767,275

(22) PCT Filed: Aug. 19, 2020
(86) PCT No.: PCT/JP2020/031265

§ 371 Date: Apr. 7, 2022

(30) Foreign Application Priority Data
Oct. 18, 2019 (JP) 2019-190841

(51) Int. Cl. G06F 3/01

(52) U.S. Cl. CPC G06F 3/016

(57) ABSTRACT

There is provided a control device including a control unit that causes a vibration presentation unit to present vibration corresponding to an input in a case where it is determined that the input for a visual element of which a display mode changes in response to the input received via an operation unit has been received, in which the control unit controls characteristics related to the vibration such that a presentation mode of the vibration changes in synchronization with a change in the display mode of the visual element.

### TECHNICAL FIELD

The present invention relates to a control device, a program, and a system.

### BACKGROUND ART

In recent years, various devices have been developed that output feedback in response to user operations. For example, Patent Literature 1 discloses a technique of performing feedback to a user's sense of touch by vibrating a touch panel in a case where the user presses the touch panel.

### CITATION LIST

### Patent Literature

Patent Literature 1: JP 2010-287231A

### SUMMARY OF INVENTION

### Technical Problem

Incidentally, in a case where feedback using vibration as described above is performed for an input operation on a graphical user interface (GUI), it can be expected that the unity between the sensations perceived by a user would be enhanced by presenting vibrations which are little different from visual expressions.

Therefore, the present invention has been made in view of the above problems, and an object of the present invention is to provide a structure capable of realizing vibration presentation with less sense of unease for an input operation on a GUI.

### Solution to Problem

In order to solve the above problem, according to one aspect of the present invention, there is provided a control device including a control unit that causes a vibration presentation unit to present vibration corresponding to an input in a case where it is determined that the input for a visual element of which a display mode changes in response to the input received via an operation unit has been received, in which the control unit controls characteristics related to the vibration such that a presentation mode of the vibration changes in synchronization with a change in the display mode of the visual element.

In order to solve the above problem, according to another aspect of the present invention, there is provided a program causing a computer to realize a control function of causing a vibration presentation unit to present vibration corresponding to an input in a case where it is determined that the input for a visual element of which a display mode changes in response to the input received via an operation unit has been received, in which, in the control function, characteristics related to the vibration are controlled such that a presentation mode of the vibration changes in synchronization with a change in the display mode of the visual element.

In order to solve the above problem, according to still another aspect of the present invention, there is provided a system including a display device that displays a visual element of which a display mode changes in response to an input received via an operation unit; a vibration presentation device that presents vibration; and a control device that causes the vibration presentation device to present the vibration corresponding to the input in a case where it is determined that the input for the visual element has been received, in which the control device controls characteristics related to the vibration such that a presentation mode of the vibration changes in synchronization with a change in the display mode of the visual element.

### Advantageous Effects of Invention

As described above, according to the present invention, there is provided a structure capable of realizing vibration presentation with less sense of unease for an input operation on a GUI.

### BRIEF DESCRIPTION OF DRAWINGS

FIG. 1 is a diagram showing a functional configuration example of a system 1 according to an embodiment of the present invention.

FIG. 2 is a diagram showing an example of display control for visual elements according to the same embodiment.

FIG. 3 is a diagram for describing an example of vibration presentation synchronized with a change in a display mode of the visual elements shown in FIG. 2.

FIG. 4 is a diagram showing an example of display control for visual elements according to an embodiment of the present invention.

FIG. 5 is a diagram for describing an example of vibration presentation synchronized with a change in a display mode of the visual elements shown in FIG. 4 according to the same embodiment.

FIG. 6 is a flowchart showing a flow of operations of the system 1 according to an embodiment of the present invention.

### DESCRIPTION OF EMBODIMENTS

Hereinafter, preferred embodiments of the present invention will be described in detail with reference to the accompanying drawings. In the present specification and the drawings, constituents having substantially the same functional configuration are given the same reference numerals, and repeated description will be omitted.

### Configuration Example

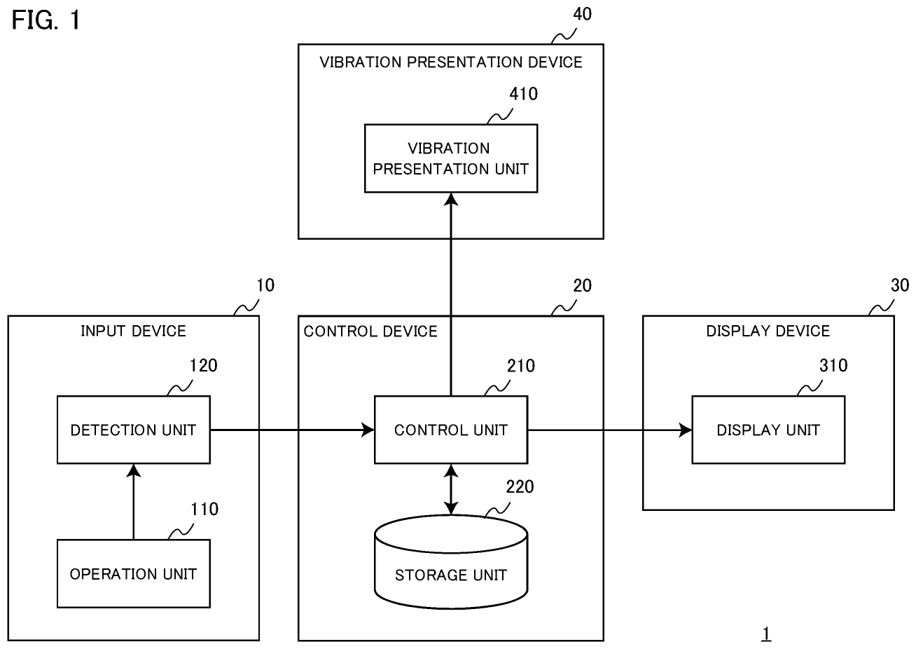

FIG. 1 is a diagram showing a functional configuration example of the system 1 according to an embodiment of the present invention. As shown in FIG. 1, the system 1 according to the present embodiment may include an input device 10, a control device 20, a display device 30, and a vibration presentation device 40.

(Input Device 10)

An input device 10 is a device that receives an input to the system 1 according to the present embodiment. The input device 10 according to the present embodiment may be, for example, a touch pad, a game controller, a line-of-sight detection device, or a gesture detection device. The input device 10 according to the present embodiment includes, for example, an operation unit 110 and a detection unit 120, as shown in FIG. 1.

The operation unit 110 according to the present embodiment may be a target object for which a user executes an input. For example, in a case where the input device 10 is a touch pad, the operation unit 110 may be a contact surface on which a user performs a tracing operation or the like. For example, in a case where the input device 10 is a game controller, the operation unit 110 may be a joystick, various buttons, or the like. The input device 10 does not necessarily have to include the operation unit 110 when the input by a user does not require a physical operation target device, such as when an input by a user is one using a line-of-sight operation or a gesture operation.

The detection unit 120 according to the present embodiment detects and receives an input. The detection unit 120 outputs information regarding the received input to the control device 20. The detection unit 120 according to the present embodiment has a configuration of being capable of detecting an assumed input. For example, in a case where the input device 10 is a touch pad, the detection unit 120 may have a pressure-sensitive sensor that converts a change in pressure that changes with an input operation on the operation unit 110 into an electrical signal, or a capacitance sensor that converts a change in a capacitance that changes with an input operation into an electrical signal.

For example, in a case where the input device 10 is a line-of-sight detection device, the detection unit 120 may include an imaging sensor for detecting a user's line of sight. For example, in a case where the input device 10 is a gesture detection device, the detection unit 120 may include an acceleration sensor, a gyro sensor, or the like for detecting a gesture of a user.

(Control Device 20)

The control device 20 according to the present embodiment controls vibration presentation by the vibration presentation device 40 on the basis of an input received by the input device 10. The control device 20 may control display of an image by the display device 30 on the basis of the input received by the input device 10. The control device 20 may control various devices (not shown) that execute a function determined by receiving an input. As shown in FIG. 1, the control device 20 according to the present embodiment includes a control unit 210 and a storage unit 220.

A function of the control unit 210 is realized by, for example, an electronic circuit such as a central processing unit (CPU) or a microprocessor. Details of the function of the control unit 210 according to the present embodiment will be described in detail separately.

The storage unit 220 according to the present embodiment stores various types of information related to operations of the control device 20, the display device 30, the vibration presentation device 40, and the like. The storage unit 220 stores, for example, an image to be displayed on the display device 30, a program for determining a display mode of the image, a program for determining a presentation mode of vibration to be presented by the vibration presentation device 40, and the like.

(Display Device 30)

The display device 30 according to the present embodiment is a device that displays various images under the control of the control device 20 and the like. The display device 30 according to the present embodiment includes, for example, a display unit 310 as shown in FIG. 1.

The display unit 310 according to the present embodiment has a function of displaying various images under the control of the control device 20 or the like. In this case, the display unit 310 displays various images according to a display mode determined on the basis of the input. Thus, the display unit 310 includes various displays and the like.

(Vibration Presentation Device 40)

The vibration presentation device 40 according to the present embodiment has a function of presenting vibration under the control of the control device 20. As shown in FIG. 1, the vibration presentation device 40 according to the present embodiment includes, for example, a vibration presentation unit 410.

The vibration presentation unit 410 according to the present embodiment presents vibration having a presentation mode determined by the control device 20. Thus, the vibration presentation unit 410 according to the present embodiment includes various actuators such as an eccentric motor (ERM: Eccentric Rotating Mass), a linear vibrator (LRA: Linear Resonant Actuator), and a piezo (piezoelectric) element capable of generating vibration.

The functional configuration example of the system 1 according to the present embodiment has been described above. The above configuration described with reference to FIG. 1 is merely an example, and a configuration of the system 1 according to the present embodiment is not limited to such an example. For example, the input device 10 and the vibration presentation device 40 may be implemented as a single device. A configuration of the system 1 according to the present embodiment may be flexibly modified according to specifications and operations.

<Details of Control>

Subsequently, details of the control of the control device 20 according to the present embodiment will be described. In the following description, it is assumed that the control device 20 according to the present embodiment controls presentation of vibration as feedback to an input to the system 1. In this case, if a difference between an image (various visual expressions) displayed by the display device 30 and vibration presented by the vibration presentation device 40 is large, a user may have sense of unease.

The technical idea according to the present invention was conceived by paying attention to the above fact, and by enhancing a sense of unity between a displayed visual expression and presented vibration, sense of unease that a user may have can be effectively reduced.

Therefore, in a case where it is determined that the control unit 210 of the control device 20 according to the embodiment of the present invention has received an input to a visual element of which a display mode changes in response to the input received via the operation unit 110, the vibration presentation unit 410 has a function of presenting vibration corresponding to the input. One of the features of the control unit 210 according to the embodiment of the present invention is that characteristics related to vibration are controlled such that a presentation mode of vibration changes in synchronization with a change in a display mode of a visual element.

Hereinafter, a function of the control unit 210 having the above features will be described in detail. In the following description, it is assumed that the user remotely performs inputting for at least one visual element displayed on the display unit 310 by using the operation unit 110 provided separately from the display unit 310. The operation unit 110 may be, for example, a touch pad provided separately from the display unit 310 that is a display.

In the following description, a case where the control unit 210 controls the display of an image including at least one visual element by the display unit 310 will be described. On the other hand, the control of the display unit 310 according to the present embodiment may be realized by another configuration provided separately from the control unit 210.

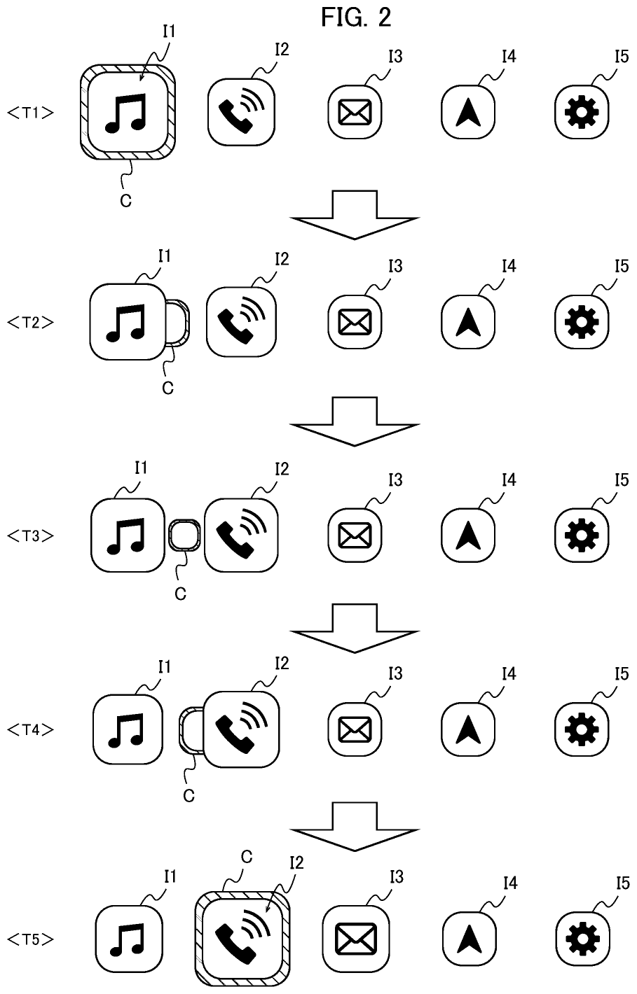

FIG. 2 is a diagram showing an example of display control for visual elements according to the present embodiment. FIG. 2 shows a display mode of the visual elements that changes in response to an input received via the operation unit 110 in a time series from the top part to the bottom part. Here, the above visual elements refer to various visual parts forming a GUI. The visual elements according to the present embodiment include, for example, an operation target object and an instruction object.

The operation target object according to the present embodiment is a visual element that is a target for receiving an input via the operation unit 110. Examples of the operation target object include an icon, a button, and a defined character string.

The instruction object according to the present embodiment is a visual element indicating an instruction position on an image (display area) displayed on the display unit 310, which is determined on the basis of an input received via the operation unit 110. An example of the instruction object is a cursor or a pointer.

One of the features of the visual elements according to the present embodiment is that a display mode changes in response to an input received via the operation unit 110. For example, the control unit 210 may control at least one of a size, a shape, and a color expression (including brightness, saturation, transparency, hue, texture, and the like) of a visual element as a display mode of the visual element.

For example, in FIG. 2, five icons I1 to I5 are shown as examples of operation target objects, and a cursor C is shown as an example of an instruction object. It is assumed that the icons I1 to I5 are arranged at equal intervals. In this case, the control unit 210 according to the present embodiment may change a size of the cursor C or the icons I1 to I5 according to a relative distance between the cursor C and the icons I1 to I5, which changes in response to an input received via the operation unit 110. For example, the control unit 210 may display an icon closest to the cursor C with the largest size and an icon second closest to the cursor C with the second largest size.

At a timing T1 shown on the top part of FIG. 2, a display position of the cursor C (the center and the centroid of the cursor C) coincides with a display position of the icon I1 (the center and the centroid of the icon I1). In this case, since a distance between the cursor C and the icon I1 is zero, the control unit 210 may display the icon I1 with the defined maximum size, and then enlarge and display the icon I2 of which a distance to the cursor C is short with a size corresponding to the distance.

The control unit 210 may control a display mode of the cursor C in addition to the display modes of the icon I1 and the icon I2. Since a distance between the cursor C and the icon I1 is zero, the control unit 210 may perform control such that the cursor C has a size (defined maximum size) along an outer periphery of the icon I1. The control unit 210 may handle this state as a state in which the icon I1 is selected, and may control execution of a function corresponding to the icon I1 according to an input corresponding to a subsequent determination operation.

At the subsequent timing T2, for example, a situation is shown in which a display position of the cursor C is moved to the right compared with the situation at the timing T1 due to the user performing a rightward tracing operation on the operation unit 110. In this case, since a distance between the cursor C and the icon I1 has become longer, the control unit 210 may perform control such that a size of the cursor C is smaller than that at the timing T1. Since a distance between the cursor C and the icon I1 has become longer, the control unit 210 may reduce a size of the icon I1 compared with that at the timing T1, and since a distance between the cursor C and the icon I2 has become shorter, increase a size of the icon I2 compared with that at timing T1.

At the subsequent timing T3, a situation is shown in which the cursor C has been moved further to the right and is located exactly in the middle between the icon I1 and the icon I2. In this case, since a distance between the cursor C and the icon I1 and a distance between the cursor C and the icon I2 are the same, the control unit 210 may perform control such that the icon I1 and the icon I2 have the same size according to the above distance. In this case, since a distance between the cursor C and the icons (the icon I1 and the icon I2) closest to the cursor C is the maximum, the control unit 210 may display the cursor C with the defined minimum size.

At the subsequent timing T4, a situation in which the cursor C has been moved further to the right is shown. In this case, since a distance between the cursor C and the icon I2 has become shorter, the control unit 210 may perform control such that a size of the cursor C is larger than that at the timing T3. Since a distance between the cursor C and the icon I1 has become longer, the control unit 210 may reduce a size of the icon I1 compared with that at the timing T3, and since a distance between the cursor C and the icon I2 became shorter, increase a size of Icon I2 compared with that at the timing T3.

At the subsequent timing T5, a situation is shown in which the cursor C has been moved further to the right and a display position thereof coincides with a display position of the icon I2. In this case, since a distance between the cursor C and the icon I2 is zero, the control unit 210 may perform control such that the icon I2 is displayed with the defined maximum size, and the cursor C has a size along the outer periphery of the icon I2. The control unit 210 may display the icon I1 and the icon I3 of which a distance to the cursor C is second shortest with a size corresponding to the distance.

An example of the change in the display mode of the visual elements according to the present embodiment has been described above. According to the control for the instruction object as described above, it is possible to effectively reduce a probability that a user loses sight of the instruction object by giving a visual change to the instruction object. According to the control for the operation target object as described above, even in a case where the instruction object is not displayed, a user can more intuitively understand an instruction position on a screen displayed on the display unit 310 and a direction of an input operation.

In the above description using FIG. 2, the case of controlling a size of a visual element has been described as an example of a display mode of the visual element. In addition, the control unit 210 may control the shape of the visual element as an example of the visual element. For example, the control unit 210 may perform control such that the instruction object or the operation target object changes from a circular shape to a quadrangular shape as a distance between the instruction object and the operation target object has become shorter.

For example, the control unit 210 may control a color expression of a visual element as an example of the visual element. For example, the control unit 210 may perform control such that the instruction object or the operation target object changes to have defined saturation, brightness, transparency, hue, texture, or the like as a distance between the instruction object and the operation target object has become shorter.

In the above description using FIG. 2, the description has been made of the case where the control unit 210 changes a display mode of an operation target object closest to an instruction object and an operation target object second closest to the instruction object among a plurality of operation target objects. On the other hand, the number of operation target objects of which a display mode is changed is not limited to the above example. The control unit 210 may change a display mode of all the operation target objects according to a distance to the cursor C.

The control of a display mode of a visual element according to the present embodiment has been described above. Subsequently, presentation control for vibration synchronized with a change in a display mode according to the present embodiment will be described in detail. The control unit 210 according to the present embodiment controls characteristics of vibration presented by the vibration presentation unit 410 such that the vibration changes in synchronization with a change in a display mode of an instruction object or an operation target object.

The above vibration characteristics include, for example, the magnitude of vibration and the sharpness of vibration. For example, in a case where a change in a display mode of a visual element reminiscent of a change in “magnitude”, the control unit 210 according to the present embodiment may perform control such that the magnitude of vibration changes in synchronization with a change in a display mode of a visual element as characteristics related to the vibration.

A display mode of a visual element reminiscent of a change in “magnitude” includes, for example, a size (display area) of the visual element as shown in FIG. 2. For example, a change in the transparency or brightness of a visual element is also expected to affect the magnitude (intensity) of a visual stimulus perceived by a user. Therefore, in a case where a size, transparency, brightness, or the like of the visual element changes in response to an input, the control unit 210 may perform control such that the magnitude of the vibration changes in synchronization with the change in the display mode as described above. In this case, the control unit 210 according to the present embodiment may change, for example, an amplitude of the frequency related to the vibration as the magnitude of the vibration. As an example, the control unit 210 may cause the vibration presentation unit 410 to present a large vibration as a visual element becomes larger, and may cause the vibration presentation unit 410 to present a smaller vibration as the visual element becomes smaller.

On the other hand, in a case where a change in a display mode of a visual element is reminiscent of a change in “sharpness”, the control unit 210 according to the present embodiment may perform control such that the sharpness of vibration changes in synchronization with a change in a display mode of a visual element as characteristics related to the vibration.

A display mode of a visual element reminiscent of a change in “sharpness” includes, for example, a shape of the visual element. As a specific example, in a case where a shape of a visual element changes between a circular shape and a polygonal shape, or in a case where the shape of the visual element gradually changes to be fine, it is assumed that a user is reminiscent of the “sharpness” in the change of the shape. For example, the saturation or hue of a visual element is also expected to greatly affect the “sharpness” felt by a user. Therefore, in a case where the above display mode of the visual element changes, the control unit 210 may perform control such that the sharpness of the vibration changes in synchronization with the change of the display mode.

In this case, for example, the control unit 210 according to the present embodiment may change a level of a frequency related to vibration as the sharpness of vibration. As an example, in a case where a shape of a visual element changes between a circular shape and a quadrangular shape, the control unit 210 may cause the vibration presentation unit 410 to present vibration at a lower frequency as the visual element becomes more similar to the circular shape, and may cause the vibration presentation unit 410 to present vibration at a higher frequency as the visual element becomes more similar to the quadrangular shape.

For example, the control unit 210 may change the type of shape of a vibration waveform that is input to the vibration presentation unit 410 as a control target as the sharpness of the vibration. As an example, in a case where a shape of a visual element changes between a circular shape and a quadrangular shape, the control unit 210 may set a vibration waveform input to the vibration presentation unit 410 to a sine wave in a case where the visual element is similar to the circular shape, and set the vibration waveform input to the vibration presentation unit 410 to a non-sine wave (for example, a saw tooth or a triangular wave) in a case where the visual element is similar to the quadrangular shape.

As described above, the control unit 210 according to the present embodiment synchronizes a display mode of the visual element with a presentation mode of the vibration by controlling the vibration characteristics according to the display mode of the changing visual element. In this case, for example, when a display mode of the visual element becomes a defined mode, the control unit 210 according to the present embodiment may cause the vibration presentation unit 410 to present vibration having a presentation mode synchronized with the defined mode.

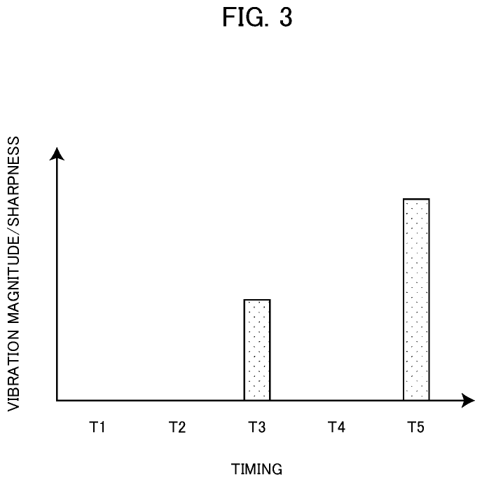

FIG. 3 is a diagram for describing an example of vibration presentation synchronized with a change in a display mode of the visual element shown in FIG. 2. FIG. 3 shows a graph showing the presence or absence of vibration presentation at the timings T1 to T5 shown in FIG. 2, and the magnitude or sharpness of the presented vibration.

The control unit 210 according to the present embodiment may change the characteristics related to vibration in synchronization with a display mode of an instruction object that changes according to a relative position with an operation target object on an image displayed on the display unit 310. For example, in the case of the example shown in FIG. 2, the control unit 210 changes the characteristics related to vibration in synchronization with a display mode of the cursor C that changes according to a relative position with an icon closest to the cursor C.

In this case, at least when a distance between one operation target object and an instruction object exceeds a first threshold value and the distance is less than a second threshold value on the image displayed on the display unit 310, the control unit 210 according to the present embodiment may cause the vibration presentation unit to present vibration synchronized with a display mode of the instruction object.

For example, in a case where the distance between the icon I1 and the cursor C is equal to or less than the first threshold value at the timing T2 shown in FIG. 2, and the distance exceeds the first threshold value at the timing T3, the control unit 210 controls the vibration presentation unit 410 such that vibration is presented at the timing T3 shown in FIG. 3. In this case, since the cursor C is displayed with the defined minimum size, the control unit 210 causes the vibration presentation unit 410 to present a relatively small vibration.

In a case where the distance between the icon I1 and the cursor C is equal to or more than the second threshold value at the timing T4 shown in FIG. 2, and the distance becomes less than the second threshold value at the timing T5, the control unit 210 controls the vibration presentation unit 410 such that vibration is presented at the timing T5 as shown in FIG. 3. In this case, since the cursor C is displayed with the defined maximum size, the control unit 210 causes the vibration presentation unit 410 to present a relatively large vibration.

According to the above control, a large vibration is presented at a timing at which a size of the cursor C is the maximum, and a small vibration is presented at a timing at which the size of the cursor C is the minimum. Therefore, it is possible to realize vibration presentation synchronized with the display mode of the visual element and thus to effectively reduce sense of unease that a user may have.

In the above description, the case where the vibration is presented in a case where the size of the cursor C is the maximum or the minimum has been described as an example. On the other hand, a timing and the number of times of presenting vibration are not limited to the above example. The control unit 210 may cause the vibration presentation unit 410 to present vibration with a medium magnitude, for example, at the timing T2 and the timing T4 shown in FIG. 2.

In a case where a change in the display mode of the cursor C is a change reminiscent of “sharpness”, for example, a shape change, the control unit 210 may cause the vibration presentation unit 410 to present vibration with a sharpness synchronized with the change in the display mode of the cursor C at the above timing.

On the other hand, the control unit 210 according to the present embodiment may cause the vibration presentation unit 410 to present vibration of which a presentation mode continuously changes in synchronization with a continuous change of a display mode of a visual element.

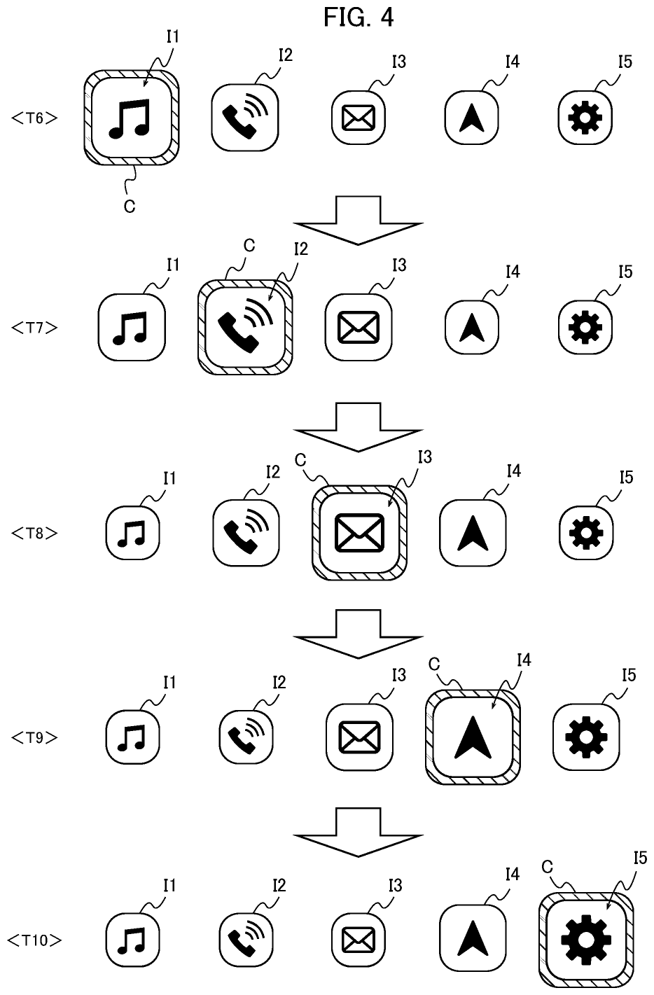

FIG. 4 is a diagram showing an example of display control for visual elements according to the present embodiment. FIG. 4 shows a display mode of the visual elements that changes in response to an input received via the operation unit 110 in a time series from the top part to the bottom part. At a timing T6, a display position of the cursor C coincides with a display position of the icon I1, and the control unit 210 displays the icon I1 with the defined maximum size. Similarly, the control unit 210 displays the icon I2 at a timing T7, the icon I3 at a timing T8, the icon 14 at a timing T9, and the icon I5 at a timing T10, with the defined maximum size.

Although not shown, it is assumed that sizes of the cursor C and each icon change according to a relative distance between the cursor C and each icon as shown in FIG. 2 between the respective timings.

In this case, for example, the control unit 210 according to the present embodiment may change characteristics related to vibration in synchronization with a display mode of an operation target object that changes according to a relative position of an instruction object on an image displayed on the display unit 310. For example, the control unit 210 may change a magnitude of vibration in synchronization with a size of an icon that changes according to a relative position of the cursor C.

In this case, the control unit 210 according to the present embodiment may cause the vibration presentation unit 410 to continuously present vibration synchronized with a display mode of an operation target object having the largest amount of change in the display mode among one or more operation target objects.

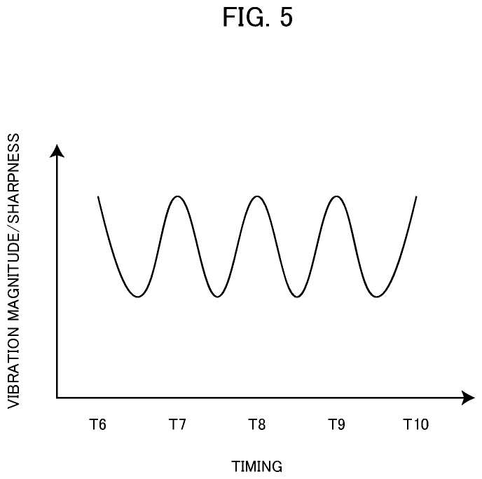

FIG. 5 is a diagram for describing an example of vibration presentation synchronized with a change in a display mode of the visual elements shown in FIG. 4. FIG. 5 shows a graph showing a time-series change in a magnitude or a sharpness of vibration from the timing T6 to the timing T10 shown in FIG. 4.

As shown in FIG. 5, the control unit 210 according to the present embodiment may cause the vibration presentation unit 410 to continuously present vibration of which the magnitude is the maximum at the timing T6, the timing T7, the timing T8, the timing T9, and the timing T10, and is the minimum between the respective timings.

According to the control as described above, among the icons of which sizes change according to reception of an input, it is possible to present vibration with a magnitude synchronized with an icon displayed with the largest size, and thus to effectively enhance the unity between production of a visual element and the presented vibration.

In a case where a change in a display mode of each icon is a change reminiscent of “sharpness”, for example, a shape change, the control unit 210 may cause the vibration presentation unit 410 to continuously present vibration with a sharpness synchronized with the change in the display mode of each icon.

<Flow of Operations>

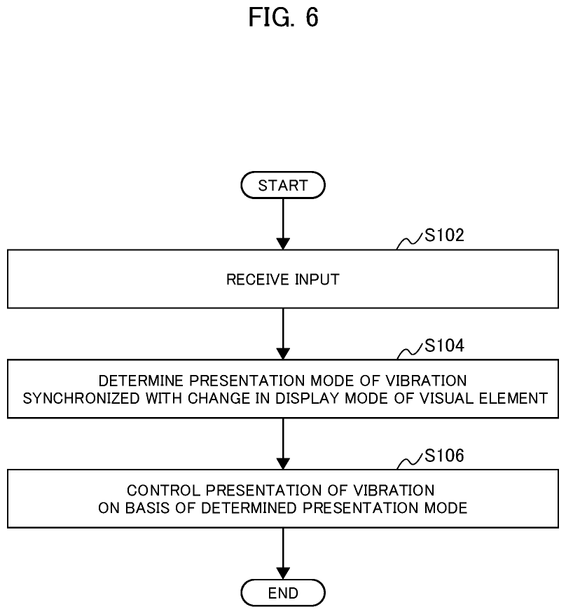

Next, a flow of operations of the system 1 according to the present embodiment will be described in detail. FIG. 6 is a flowchart showing a flow of operations of the system 1 according to the present embodiment.

First, the detection unit 120 detects an input via the operation unit 110 and receives the input (S102).

Next, the control unit 210 determines a presentation mode of vibration synchronized with a change in a display mode of a visual element corresponding to the input received in step S102 (S104). In this case, the control unit 210 may determine a display correspondence of the visual element corresponding to the input, and control display of the visual element by the display unit 310 on the basis of the display mode.

Next, the control unit 210 controls vibration presentation by the vibration presentation unit 410 on the basis of the presentation mode determined in step S104 (S106).

### APPENDIX

Although the preferred embodiments of the present invention have been described in detail with reference to the accompanying drawings, the present invention is not limited to these examples. It is clear that a person skilled in the art can conceive of various modifications or alterations within the scope of the technical ideas described in the claims, and these are also naturally understood to belong to the technical scope of the present invention.

For example, in the above embodiment, the case where a visual element changes according to a conscious input by a user has been described as a main example. On the other hand, a visual element may change according to an unconscious input by a user, an input due to an environmental change, or an input due to a state change of a target device. For example, the visual element may change with a distance from the input device 10 or the like as an input. For example, the visual element may change with a change in loudness of environmental sound, a change in temperature, or the like as an input. For example, the visual element may change with a speed of a vehicle on which the system 1 is mounted as an input. Even in such a case, according to the control method described above, it is possible to realize presentation of vibration synchronized with a change in a visual element.

For example, the series of processes by each device described in the present invention may be realized by using any of software, hardware, and a combination of software and hardware. Programs constituting the software are stored in advance in, for example, a recording medium (non-transitory medium) provided inside or outside each device. Each program is read to a RAM at the time of execution by a computer and executed by a processor such as a CPU. The recording medium is, for example, a magnetic disk, an optical disk, a magneto-optical disk, a flash memory, or the like. The above computer program may be distributed, for example, via a network without using a recording medium.

### REFERENCE SIGNS LIST

1 system
10 input device
110 operation unit
120 detection unit
20 control device
210 control unit
220 storage unit
30 display device
310 display unit
40 vibration presentation device
410 vibration presentation unit

1. A control device comprising:
a control unit that causes a vibration presentation unit to present vibration corresponding to an input in a case where it is determined that the input for a visual element of which a display mode changes in response to the input received via an operation unit has been received, wherein
the control unit controls characteristics related to the vibration such that a presentation mode of the vibration changes in synchronization with a change in the display mode of the visual element.

2. The control device according to claim 1, wherein
the control unit controls a magnitude of the vibration as the characteristics related to the vibration such that the magnitude of the vibration changes in synchronization with the change in the display mode of the visual element.

3. The control device according to claim 2, wherein
the control unit changes an amplitude of a frequency related to the vibration as the magnitude of the vibration.

4. The control device according to claim 2, wherein
the control unit controls a sharpness of the vibration as the characteristics related to the vibration such that the sharpness of the vibration changes in synchronization with the change in the display mode of the visual element.

5. The control device according to claim 4, wherein
the control unit changes a level of a frequency related to the vibration as the sharpness of the vibration.

6. The control device according to claim 4, wherein
the control unit changes the type of shape of a vibration waveform that is input to the vibration presentation unit as a control target as the sharpness of the vibration.

7. The control device according to claim 1, wherein
the display mode of the visual element includes at least one of a size, a shape, and a color expression of the visual element.

8. The control device according to claim 1, wherein
the visual element is an element displayed on a display unit, and includes at least one of one or more operation target objects that are targets related to an input received via the operation unit and an instruction object indicating an instruction position determined on the basis of the input received via the operation unit.

9. The control device according to claim 8, wherein
the control unit changes the characteristics related to the vibration in synchronization with a display mode of the instruction object that changes according to a relative position with the operation target object on an image displayed on the display unit.

10. The control device according to claim 9, wherein
at least in a case where a distance between one of the operation target objects and the instruction object exceeds a first threshold value on the image displayed on the display unit and the distance is less than a second threshold value, the control unit causes the vibration presentation unit to present the vibration synchronized with the display mode of the instruction object.

11. The control device according to claim 8, wherein
the control unit changes the characteristics related to the vibration in synchronization with a display mode of the operation target object that changes according to a relative position with the instruction object on an image displayed on the display unit.

12. The control device according to claim 11, wherein
the control unit causes the vibration presentation unit to continuously present the vibration synchronized with a display mode of an operation target object of which an amount of change in the display mode is largest among the one or more the operation target objects.

13. A non-transitory computer readable storage medium storing a program, the program causing a computer to realize:
a control function of causing a vibration presentation unit to present vibration corresponding to an input in a case where it is determined that the input for a visual element of which a display mode changes in response to the input received via an operation unit has been received, wherein
in the control function, characteristics related to the vibration are controlled such that a presentation mode of the vibration changes in synchronization with a change in the display mode of the visual element.

14. A system comprising:
a display device that displays a visual element of which a display mode changes in response to an input received via an operation unit;
a vibration presentation device that presents vibration; and
a control device that causes the vibration presentation device to present the vibration corresponding to the input in a case where it is determined that the input for the visual element has been received, wherein
the control device controls characteristics related to the vibration such that a presentation mode of the vibration changes in synchronization with a change in the display mode of the visual element.
